(19) United States
(12) Patent Application Publication
(10) Pub. No.: US 2008/0095605 A1
(43) Pub. Date: Apr. 24, 2008

(54) Dispenser and Components Thereof

(75) Inventors: Paul Omdoll, Waukesha, WI (US); Scott Collins, Milwaukee, WI (US); Brian Hubanks, Dousman, WI (US); Michael Young, Mukwonago, WI (US); James Walsh, Wauwatosa, WI (US)

Correspondence Address: BOYLE FREDRICKSON S.C., 840 North Plankinton Avenue, MILWAUKEE, WI, 53203, US

(73) Assignee: THE COLMAN GROUP, INC., Elkhorn, WI (US)

(21) Appl. No.: 11/571,166

(22) PCT Filed: Jun. 24, 2005
(86) PCT No.: PCT/US05/22270

§ 371 Date: Dec. 22, 2006

Related U.S. Application Data
(60) Provisional application No. 60/582,940, filed on Jun. 25, 2004.

(51) Int. Cl. B65G 59/02

(52) U.S. Cl. 414/796.5; 414/800

(57) ABSTRACT

An adapter for a cup dispenser that can be used to replace flexible diaphragms so as to improve wear characteristics. Each adapter is preferably interchangeable with other adapters sized to accommodate other different cup sizes and shapes. The adapter includes two or more rows of preferably offset restrictions to stage and separate cups for easy dispensing. The invention also comprises a cup dispenser incorporating such an adapter and a method of interchanging a flexible diaphragm with such an adapter.

### BACKGROUND OF THE INVENTION

This invention relates generally to dispensers and more particularly to cup dispensers.

Dispensers are widely used to store and dispense beverage cups. Typically, a stack of nested cups is held by a dispenser so that a portion of the cup is exposed. An individual desiring a cup simply pulls on the exposed portion of the cup, and removes the cup from the dispenser.

Currently, three types of cup dispensers are generally used in the commercial and industrial food markets. All three types of dispensers have an opening and use a spring biased platform to urge cups towards the opening. The three types of dispensers have different structures associated with the opening. One type of beverage cup dispenser has a fixed rim that is configured to dispense a single cup size. Fixed rim dispensers do not generally experience much wear from use. However, they cannot accommodate different cups sizes so that many different dispensers are required to meet all cup needs. In order to adjust for even the slightest variation in cup size, a customer must purchase or deploy a new dispenser at a substantial cost.

Another type of dispenser is an adjustable dispenser. This type of dispenser uses spring clips or the like that can be adjusted to dispense multiple cup sizes. U.S. Pat. No. 4,126,248 to House; U.S. Pat. No. 4,033,478 to House, and U.S. Pat. No. 4,658,983 to Suttles disclose a number of these adjustable dispensers. While adjustable dispensers generally do not experience much wear from use, they are often difficult to adjust to properly accommodate different size cups and require training and skill to be used at all The spring clips often get bent, thus ruining or severely damaging the dispenser.

The third type of dispenser employs a flexible diaphragm instead of a fixed rim. This type of dispenser has a removable flexible diaphragm through which cups are pulled. The flexible diaphragm has an opening that may be varied to accommodate cups of different sizes. U.S. Pat. No. 5,709,316 to Jolly et al. and U.S. Pat. No. 6,199,723 to Collins et al. disclose cup dispensers with flexible diaphragms. Flexible diaphragms are relatively inexpensive to manufacture and can be readily shaped in accordance with the needs of a food service organization. As such, a dispenser can be fit with diaphragms having different sized and shaped openings at a relatively low expense. Flexible diaphragms, however, are subject to wear. As such, they need to be periodically replaced and thus, have ongoing costs associated with their use.

The current dispensers suffer from certain drawbacks and limitations. Accordingly, a need exists for dispensers that are easy to use, do not wear over time and are flexible to changing or multiple cup needs, and solve other problems associated with the existing designs.

### SUMMARY OF THE INVENTION

In one embodiment of the present invention, a device is provided that converts a flexible diaphragm dispenser to a fixed rim dispenser. Preferably, this conversion is accomplished without the use of any tools.

In another embodiment of the present invention, a dispenser is provided that employs an interchangeable fixed rim insert.

In accordance with one aspect of the present invention, a dispenser having a flexible diaphragm positioned between the removable retainer and the housing is removed and replaced by a fixed rim insert (or adapter). The removable retainer ring is removed from the housing and the flexible diaphragm is taken away. A fixed rim insert having a central dispensing tube is fitted to the removable retainer ring. The central dispensing tube is placed down into the dispenser's cup storage tube and the removable retainer is secured to the housing. This process may be reversed or the fixed rim insert may be interchanged with other fixed rim inserts of different sizes, depending upon the needs of the user.

The ability to replace flexible diaphragms with interchangeable fixed rim inserts can provide significant benefits. For example, since the fixed rim inserts exhibit little or no wear under normal use conditions, they can be maintained in place without the need for servicing or additional expenditure on a regular basis. Still further, a food service company can have the benefit of fixed rim dispensers, and because of the interchangeability afforded by the present invention, it need not maintain or pay for myriad different dispensers. Moreover, when configured with multiple offset rows of dispensing bumps or ribs (i.e., restrictions), fixed rim inserts in accordance with the present invention actually provide improved dispensing. The fixed rim inserts of the present invention are simple to use, require no adjustment, allow the dispenser to be adapted to different size cups, in place, without modification of the counter on which they are mounted and can be certified for food safety by the National Sanitation Foundation. These and other objects and advantages of the present invention will become apparent from the detailed description, claims, and accompanying drawings.

### DESCRIPTION OF THE DRAWINGS

FIG. 1 is a perspective view of a portion of a dispenser in accordance with one embodiment of the present invention undergoing the removal of a flexible diaphragm;

FIG. 2 is a perspective view of the dispenser of FIG. 1 shown with a removable retainer ring and a flexible diaphragm being removed from the retainer ring;

FIG. 3 is a top view of a fixed rim insert in accordance with the present invention indicating the manner of its engagement with the retainer ring shown in FIG. 2.

FIG. 4 is a perspective view of a portion of a dispenser and housing showing the insertion of the fixed rim insert and retainer ring into the dispenser

FIG. 5 is a perspective view of the dispenser of FIG. 1 shown with the retainer ring and fixed rim insert being rotated into place in the dispenser;

FIG. 6 is a perspective view of the dispenser of FIG. 1 shown with the retainer ring and fixed rim insert secured to the dispenser and cups being positioned in the dispenser;

FIG. 7 is top perspective view of a fixed rim insert in accordance with one embodiment of the present invention;

FIG. 8 is a bottom perspective view of the fixed rim insert of FIG. 7;

FIG. 9 is a top view of the fixed rim insert of FIG. 7;

FIG. 10 is a side view of the fixed rim insert of FIG. 7;

FIG. 11 is an exploded cross-sectional view of a prior art flexible diaphragm cup dispenser;

FIG. 12 is an exploded cross-sectional view of the cup dispenser of FIG. 11, with a fixed rim insert in accordance with the present invention in place of the flexible diaphragm; and

FIG. 13 is a perspective exploded view of a fixed rim insert in accordance with another embodiment of the present invention.

### DETAILED DESCRIPTION OF THE PREFERRED EMBODIMENTS

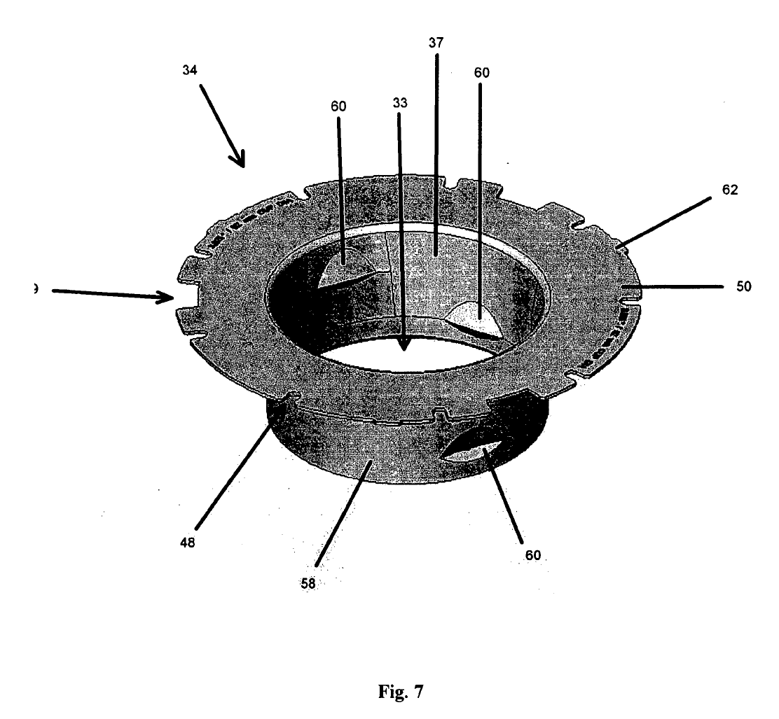

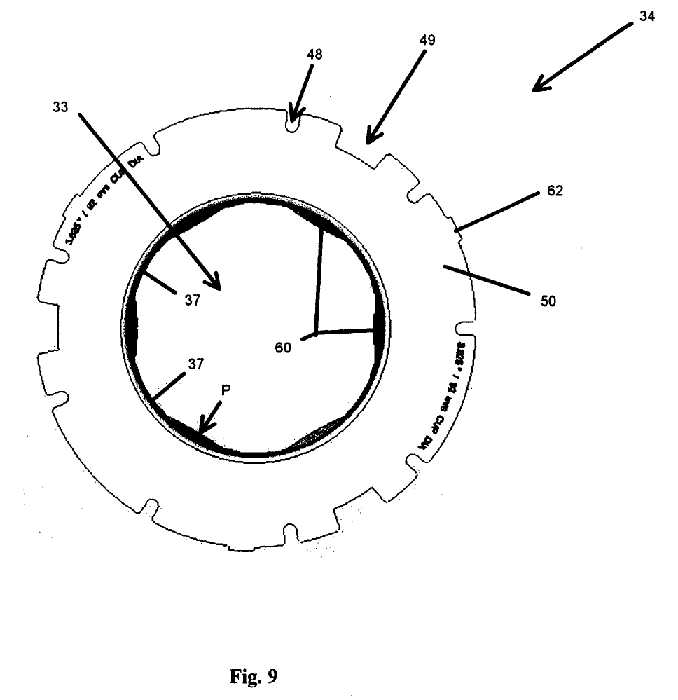

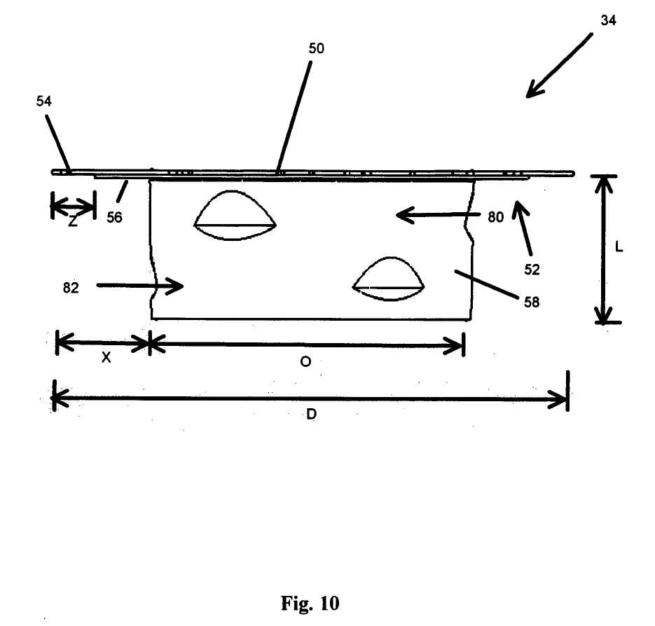

The present invention comprises a fixed rim insert 34 and dispensers therefore. As shown in FIG. 7-10, the fixed rim insert 34 has an outer rim 50, and a central dispensing tube 58. The fixed rim insert 34 is intended to replace a flexible diaphragm in certain conventional cup dispensers. It can also be used to retrofit existing fixed rim cup dispensers to modify their diameter and thereby alter the size and/or type of the cup that can be dispensed.

Preferably, the fixed rim insert 34 is made from a substantially rigid material. Such material can include acetal or ABS, but can be any material that exhibits little or no wear over time.

The opening 33 of the fixed rim insert 34 has a diameter O to accommodate cups of a given shape or size. In one embodiment, the opening 33 has a diameter O of about 3¾ inches and accommodates cups with mouths having a slightly smaller diameter. However, the opening 33 may be any size that accommodates a cup for which dispensing is desired.

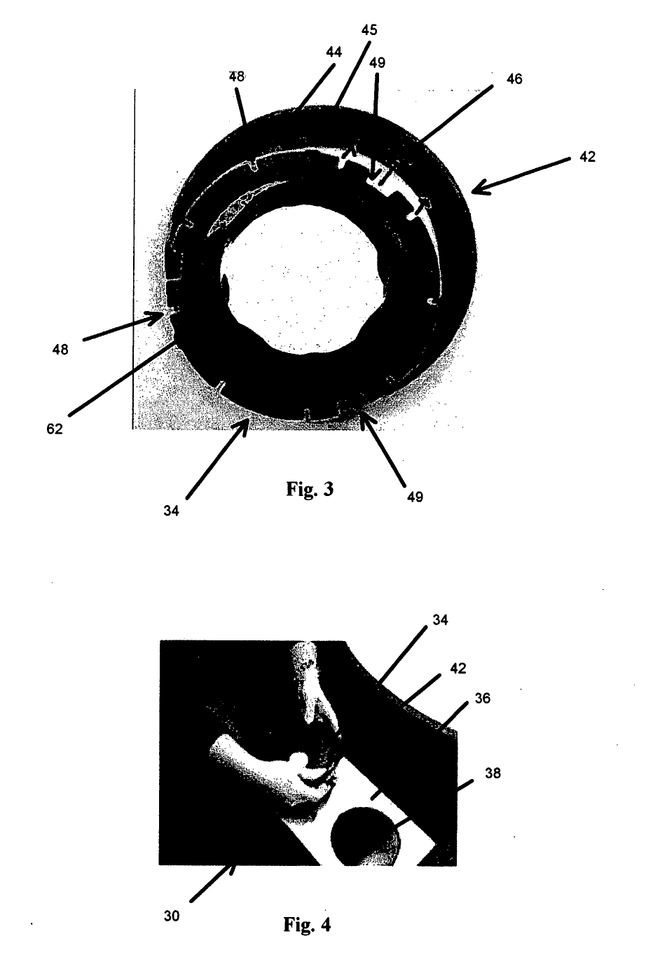

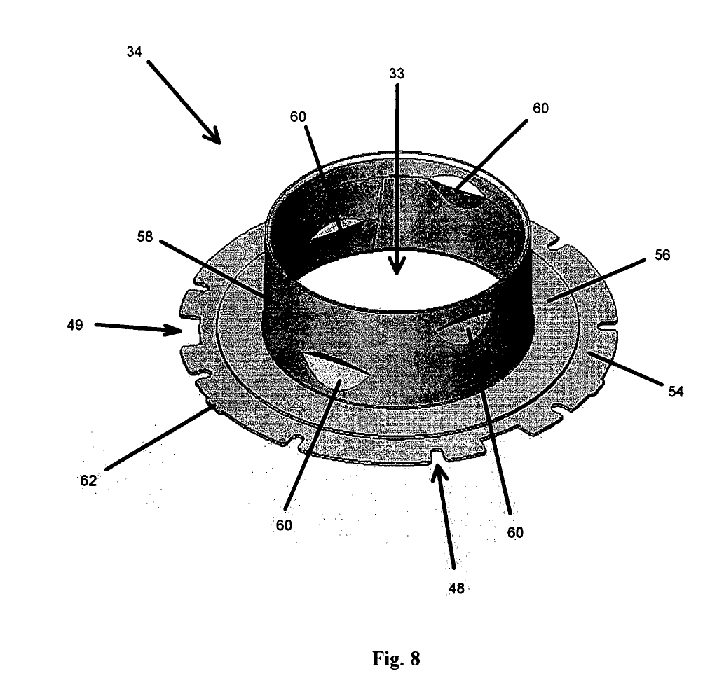

As shown in FIG. 10, a lip 52 may extend a distance X, preferably between about 1 to 1¼ inches, between the opening 33 and the outer rim 50. As shown in FIGS. 8 and 10, the lip 52 may have an outer portion 54 and an inner portion 56. As shown in FIG. 10, the outer portion 54 extends a distance Z beyond the inner portion 56, preferably between about ½ and ¾ of an inch. As shown in FIG. 3, the outer portion 54 of the fixed rim insert 34 contacts the collar 45 of the retainer ring 42. The outer portion 54 may have additional complimentary structures, as such as securing slots 48, cutouts 49 and/or prongs 62 to securely position the fixed rim insert 34.

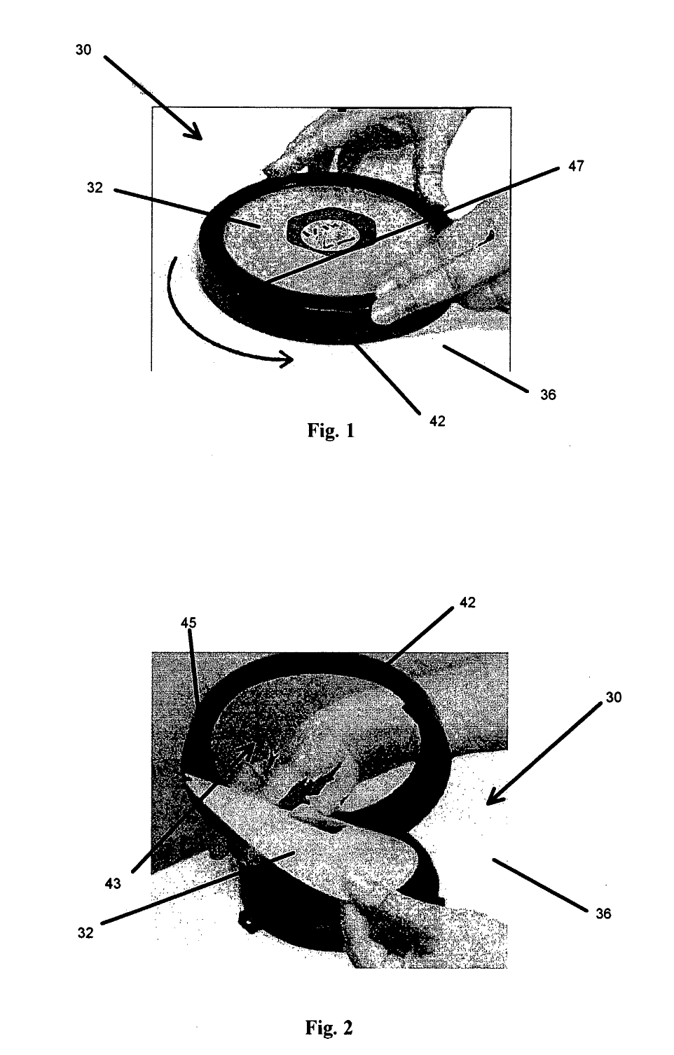

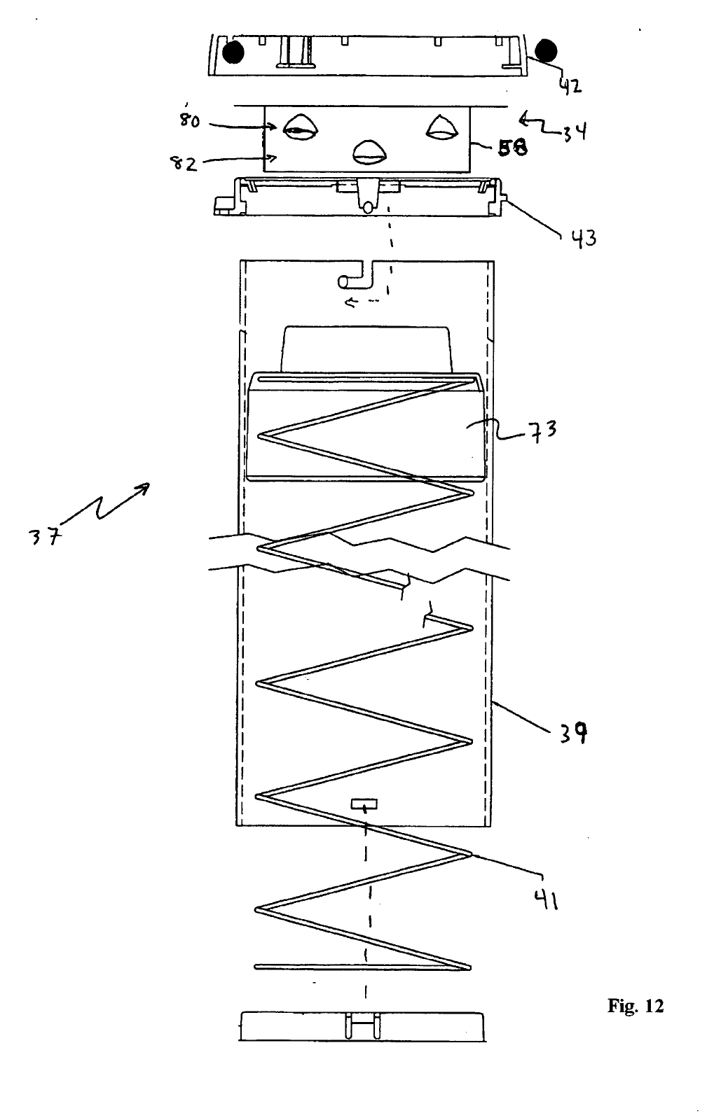

A central dispensing tube 58 has a length L, preferably between about 1¾ and 2 inches, that extends into a cup storage tube 37. (See FIG. 12). The sleeve 58 may have additional structure designed to facilitate holding and/or dispensing cups. For example, the sleeve 58 may have ribs or bumps 60 that selectively reduce the diameter of the central dispensing tube 58 to hold but still allow selective withdrawal of appropriately sized cups. Alternatively, the central dispensing tube 58 can include flexible spring loaded pieces as disclosed in FIGS. 1-3 of U.S. Pat. No. 4,126,248 to House which are hereby incorporated by reference, or may include adjustable rollers as disclosed in FIGS. 1-2 of U.S. Pat. No. 4,426,017 to Ficken et al., which are hereby incorporated by reference.

As shown in FIGS. 7-10, bumps (or restrictions) 60 can be in a variety of shapes but are preferably in the form of wedges positioned in two or more rows around the sleeve 58, where each row is a different distance away from the face 37 of the fixed rim insert 34. As shown in FIG. 14, the bumps 60 preferably have a generally rounded triangular shape with an elliptical base (wedge shaped) and extend a maximum distance from the sleeve 58 at a point P. Most preferably, the wedges 60 alternate in alignment between the rows. In other words, the bumps 60 are staggered or offset as between the rows.

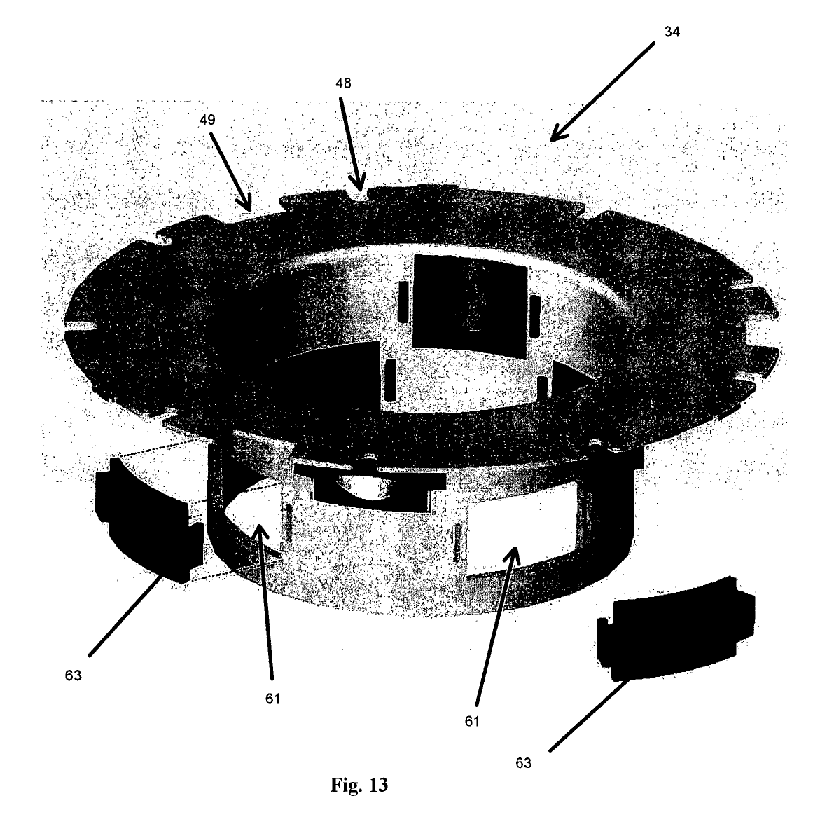

As shown in FIG. 13, in another embodiment of the present invention, the fixed rim insert 34 is made without bumps and with holes or cutouts 61 in the locations where bumps might be placed. In such case, separate bump pieces or sections 63 can be fit into the holes to create the same effect as a fixed rim insert 34 with integral bumps. In still other embodiments, bumps can be deployed on the inside of the fixed rim insert by using an external sleeve having bumps that fit into cutouts 61 or by using an internal sleeve arrayed with bumps that fits into fixed rim insert.

Illustrative embodiments of a dispenser (identified generally as 30) and a fixed rim insert (identified generally as 34) in accordance with the present invention are shown in FIGS. 1-6 and 11-12.

Dispensers using flexible diaphragms 32 have been in use for many years. An example of a flexible diaphragm dispenser includes that disclosed in U.S. Pat. No. 5,709,316 to Jolly et al., which is hereby incorporated in its entirety for all purposes.

The dispenser 30 can accommodate both flexible diaphragms 32 and fixed rim inserts in accordance with the present invention. Preferably, the dispenser 30 can be fit with and changed between flexible diaphragms 32 and fixed rim inserts 34 without the use of any tools.

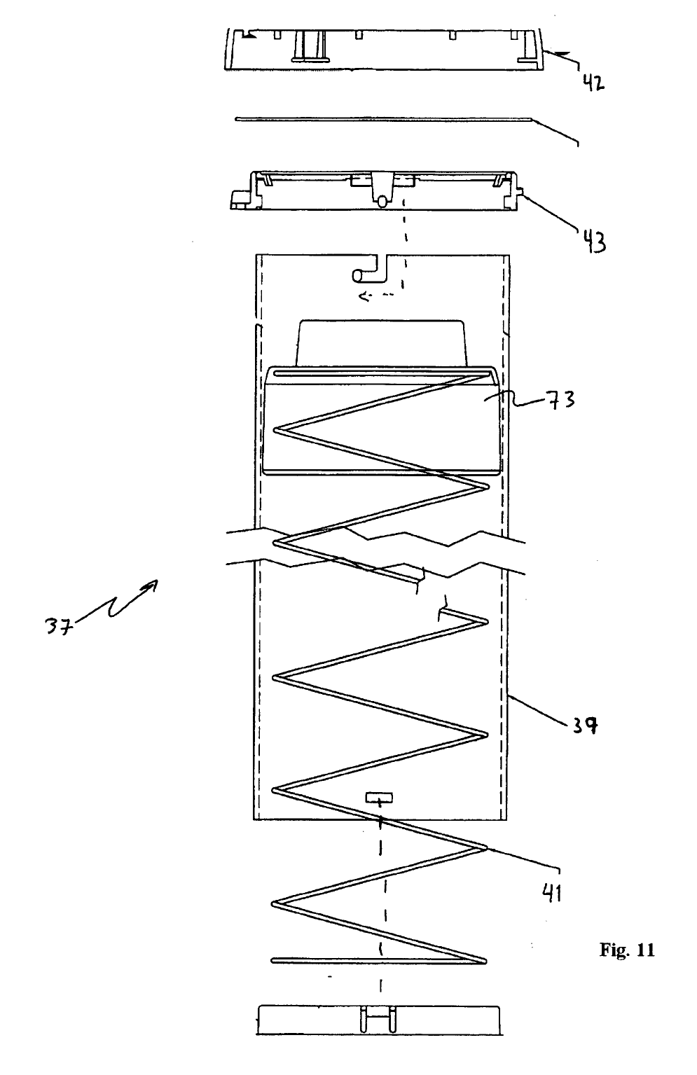

The dispenser 30 of the present inventions may be used in connection with dispensing beverage cups. As shown in FIG. 1, the dispenser 30 has a housing 36 with at least one opening 38. The housing 36 and opening 38 may be any shape or size depending on a variety of characteristics such as the area in which the dispenser will be used and the size and shape of the cups to be dispensed. For example, the housing 36 may be a standalone structure or may be a counter or cabinet. Residing within the housing are one or more cup storage assemblies 37 as shown in FIGS. 11 and 12. These assemblies 37 include a cup storage tube 39, preferably a biasing means such as a spring 41 that fits within the tube 39 and a cup support 73. A circumferential collar 43 is fitted on the top of the tube 39 and has an outside diameter greater than the tube 39 and greater than the opening 38 in the housing 36. As such, the cup storage assembly 37 can be placed in the housing and maintained in place by one or more fasteners (not shown) affixing the circumferential collar 43 to the housing. A fixed rim insert 34, having a central dispensing tube 45, is fitted into the tube 39 and then held in place by a removable retainer ring 42. Preferably the retainer ring 42 may be removed without the use of tools. For example, the retainer ring 42 may screw onto the housing 36. An example of this basic construction (with the exception of the fixed rim insert 34) is disclosed in U.S. Pat. No. 6,003,724 to Collins et al., which is hereby incorporated in its entirety for all purposes.

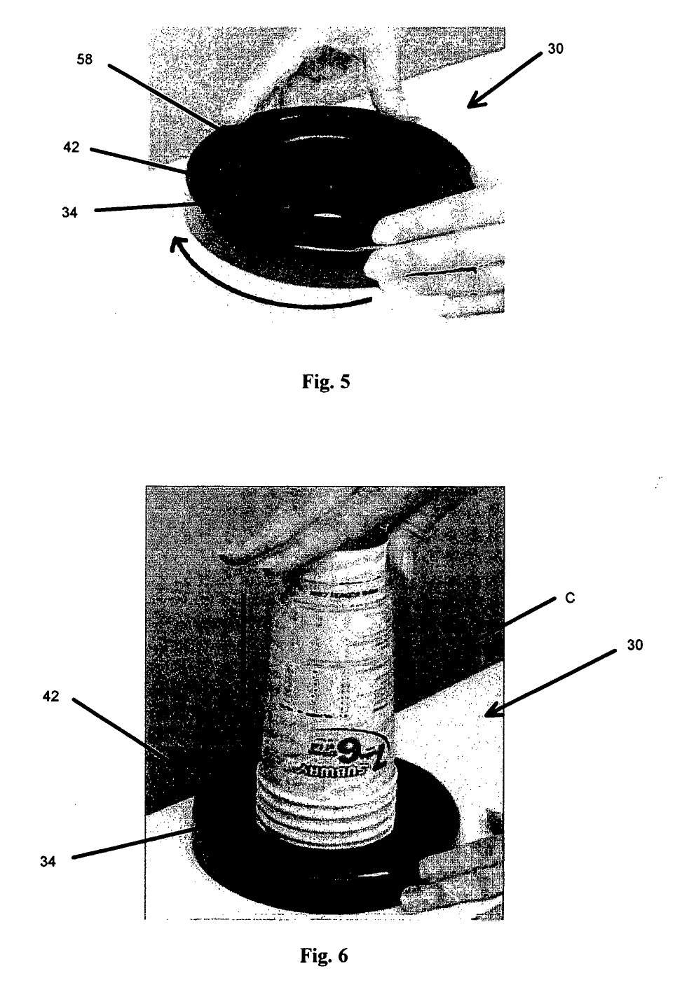

As shown in FIGS. 1, 5-6, 11 and 12, the retainer ring 42 and the collar 43 hold the fixed rim insert or diaphragm 34 in place. As shown in FIG. 5, the retainer ring 42 has a rim 47 and an opening 43. The rim 47 has a collar 45. The fixed rim insert 34 has a diameter that is smaller than the outer diameter of the rim 47 of the retainer ring 42 but larger than the diameter of the opening 43 of the retainer ring 42. Therefore, as shown in FIG. 7, a portion of the face 37 of the fixed rim insert 34 fits against the collar 45 when the fixed rim insert 34 is positioned in the removable retainer ring 42. As shown in FIG. 12 and as noted above, the fixed rim insert 34 is sandwiched between the collar 45 of the retainer ring 42 and the circumferential collar 43.

As shown in FIG. 3, the retainer ring 42 may have additional complimentary structure to securely position the fixed rim insert 34. In the embodiments shown in FIG. 3, the retainer ring 42 has a plurality of securing pins 44. As shown in FIG. 13, these pins 44 fit into corresponding slots 48 in the fixed rim insert 34.

Further, as shown in FIGS. 7-9, the retainer ring 42 may have a plurality of securing tabs 46. As shown in FIG. 3, the fixed rim insert 34 may have cutouts 49 corresponding to the securing tabs 46. The fixed rim insert 34 may thus, be fit into the retainer ring 42, thereby forcing the cutouts 49 over the tabs 46.

In addition, as shown in FIGS. 7-9, the fixed rim insert 34 may have prongs 62 and the retainer ring 42 may have corresponding slots. The prongs 62 fit into the slots, thereby further securing the fixed rim insert 34 to the removable retainer 42.

In operation, the dispenser 30 can be easily and quickly converted from using a flexible diaphragm 32 to a fixed rim insert 34 and back again. Similarly, fixed rim insert 34 can be interchanged with other fixed rim inserts having varying diameters of their central opening so as to accommodate different cup sizes. Preferably, these conversions can be accomplished without the use of any tools.

One method of converting a dispenser 30 from using a flexible diaphragm 32 to using a fixed rim insert 34 is shown in FIGS. 1-6. As shown in FIG. 1, the retainer ring 42 is removed from the housing 36 of the dispenser 30, preferably by unscrewing or otherwise releasing the retainer 42. As shown in FIG. 2, the flexible diaphragm 32 is disengaged from the retainer ring 42. As shown in FIG. 3, a fixed rim insert 34 is fit into the retainer ring 42. As shown in FIG. 4, the central dispensing tube 45 of the fixed rim insert 34 is fit into the cup storage tube 37 and the retainer ring 42 is aligned with the circumferential collar 43. As shown in FIG. 5, the retainer ring 42 is secured to the circumferential collar 43 thereby sandwiching the fixed rim insert 34 in place. As shown in FIG. 6, a stack of cups C is pushed through the diaphragm 34 and onto a cup support 73. (See FIG. 12). The support 73, biased by spring 41, urges the stack of cups C toward the retainer ring 42 so that a portion of the uppermost cup in the stack C extends outside the dispenser 30. As shown in FIG. 12, a user removes a cup from the stack C by pulling on the exposed portion. The fixed rim insert 34 allows cups, and preferably a single cup, to be dispensed while retaining the remaining cups in the dispenser 30. When a cup is pulled from the stack C, the two rows of bumps function to separate the next two cups in the stack by deforming them in opposite directions. More particularly, the two offset rows of bumps 60 create two distinct dispensing areas. The bottom row 82, the row farthest from the cup discharge point, acts as a staging area. The top row 80, the row closest to the cup discharge point, acts as a discharge area. Thus, a cup in the staging area is held in place by the bumps in the bottom row 82 while a cup in the discharge area is held separately and apart from the cup in the staging area by the bumps in the top row 80.

The dispenser 30 and fixed rim insert 34 of the present invention may have other applications aside from use in connection with cups. Further, the invention may be implemented in a variety of configurations, using certain features or aspects of the several embodiments described herein and others known in the art. Thus, although the invention has been herein shown and described in what is perceived to be the most practical and preferred embodiments, it is to be understood that the invention is not intended to be limited to the specific features and embodiments set forth above. Rather, it is recognized that modifications may be made by one of skill in the art of the invention without departing from the spirit or intent of the invention and, therefore, the invention is to be taken as including all reasonable equivalents to the subject matter disclosed herein.

1. A cup dispenser comprising:
a tubular receptacle for holding a plurality of cups to be dispensed;
an interchangeable adapter defining an inner area mounted to said tubular receptacle, custom fit to a particular cup type and size; and
a plurality of restrictions associated with said interchangeable adapter to hold and release cups held in said tubular receptacle .

2. A cup dispenser according to claim 1, wherein said interchangeable adapter will not suffer wear under normal use conditions.

3. A cup dispenser according to claim 2, wherein said interchangeable adapter is made from a substantially rigid plastic material.

4. A cup dispenser according to claim 3, wherein said interchangeable adapter is made from acetal or ABS.

5. A cup dispenser according to claim 1, wherein said plurality of restrictions are arranged in at least two rows and extend into the inner area defined by said interchangeable adapter.

6. A cup dispenser according to claim 7, wherein said plurality of restrictions are offset from one another such that they alternate in alignment between the at least two rows.

7. A cup dispenser according to claim 1, wherein said restrictions are not integral with said interchangeable adapter.

8. A cup dispenser according to claim 1, wherein said interchangeable adapter includes a flange for attaching said adapter to said tubular receptacle.

9. A cup dispenser according to claim 1, wherein said interchangeable adapter is interchangeable with a flexible diaphragm sized to hold and release cups of a predetermined size range.

10. A cup dispenser according to claim 9, wherein said interchangeable adapter is interchangeable without the use of tools.

11. A cup dispenser according to claim 10, wherein said interchangeable adapter is interchangeable with other interchangeable adapters that are fit to a different cup size and shape.

12. A cup dispenser according to claim 1, wherein said interchangeable adapter is interchangeable with other interchangeable adapters that are fit to a different cup size and shape.

13. An interchangeable adapter for a cup dispenser comprising:
a sleeve defining an inner area, wherein said sleeve fits at least partially inside a cup
holding receptacle, and wherein said sleeve is sized to hold and release cups of a predetermined size and shape; and
a plurality of restrictions extending into said inner area defined by said sleeve for assisting in the holding and releasing of cups.

14. An interchangeable adapter for a cup dispenser according to claim 13, wherein said adapter will not suffer wear under normal use conditions.

15. An interchangeable adapter for a cup dispenser according to claim 14, wherein said adapter is made from a substantially rigid plastic material.

16. An interchangeable adapter for a cup dispenser according to claim 15, wherein said plurality of restrictions are arranged in at least two rows within the inner area defined by said interchangeable adapter.

17. An interchangeable adapter for a cup dispenser according to claim 16, wherein said plurality of restrictions are offset from one another such that they alternate in alignment between the at least two rows.

18. An interchangeable adapter according to claim 13, wherein said interchangeable adapter is interchangeable with a flexible diaphragm sized to hold and release cups of a predetermined size range.

19. An interchangeable adapter according to claim 18, wherein said interchangeable adapter is interchangeable with other interchangeable adapters that are fit to a different cup size and shape.

20. A cup dispenser according to claim 19, wherein said interchangeable adapter is interchangeable without the use of tools.

21. An interchangeable adapter according to claim 13, wherein said interchangeable adapter is interchangeable with other interchangeable adapters that are fit to a different cup size and shape.

22. A cup dispenser comprising:
a receptacle for holding a plurality of cups to be dispensed, wherein said receptacle has dispensing and non-dispensing ends;
a dispensing element located proximate said dispensing end of said receptacle, wherein said dispensing element comprises a plurality of restrictions arranged in at least two offset and substantially parallel rows and wherein said rows of restrictions separate the frontmost cups held in a stack in said receptacle at said dispensing end by deforming them in at least two different directions and creating at least two distinct dispensing areas.

23. A dispenser according to claim 22, wherein said dispensing element is custom fit to a particular cup type and size.

24. A dispenser according to claim 23, wherein said dispensing element is interchangeable with other dispensing elements sized to accommodate different sizes and types of cups.

25. A dispenser according to claim 24, wherein said dispensing element is interchangeable with a flexible diaphragm sized to hold and release cups of a predetermined size range.

26. A cup dispenser according to claim 25, wherein said interchangeable adapter is interchangeable without the use of tools.

27. A dispenser according to claim 22, wherein said restrictions are in the form of bumps.

28. A method of improving the wear characteristics of flexible diaphragm cup dispenser comprising the steps of:
removing the flexible diaphragm from the cup dispenser;
selecting an adapter made from a material exhibiting low wear and custom fit to a desired cup type and size; and
replacing the flexible diaphragm with said interchangeable adapter.
